(19) United States
(12) Patent Application Publication
(10) Pub. No.: US 2012/0135741 A1
(43) Pub. Date: May 31, 2012

(54) METHOD, DEVICE AND USER EQUIPMENT FOR CONFIGURING REFERENCE SIGNAL

(75) Inventors: Mingyu ZHOU, Beijing (CN); Kunpeng LIU, Beijing (CN)

(73) Assignee: Huawei Technologies Co., Ltd., Shenzhen (CN)

(21) Appl. No.: 13/368,126

(22) Filed: Feb. 7, 2012

Related U.S. Application Data
(63) Continuation of application No. PCT/CN2010/075767, filed on Aug. 6, 2010.

(30) Foreign Application Priority Data
Aug. 7, 2009 (CN) 200910091107.0
Oct. 28, 2009 (CN) 200910208770.4

(51) Int. Cl. H04W 72/04

(52) U.S. Cl. 455/450

(57) ABSTRACT

Embodiments of the present invention relate to a method, device and user equipment for configuring a reference signal (RS). The method includes: acquiring group number information of a RS allocated for a UE respectively by each cell; acquiring, according to the group number information, group offset information of a RS of a UEm served by at least two cells at the same time in the UE; and sending the group offset information to the UEm, so that the UEm acquires new group number information according to the allocated group number information of the RS and the group offset information, and sends a RS according to the new group number information. In the method, a RS is sent according to new group number information, thereby avoiding interference generated by a UE in each cell on a scheduled UEm when an eNB schedules the UEm.

### CROSS-REFERENCE TO RELATED APPLICATIONS

This application is a continuation of International Application No. PCT/CN2010/075767, filed on Aug. 6, 2010, which claims priority to Chinese Patent Application No. 200910091107.0, filed on Aug. 7, 2009 and Chinese Patent Application No. 200910208770.4, filed on Oct. 28, 2009, all of which are hereby incorporated by reference in their entireties.

### FIELD OF THE INVENTION

The present invention relates to the field of communications technologies, and in particular, to a method, a device and a user equipment for configuring a reference signal.

### BACKGROUND OF THE INVENTION

In a conventional communications system, a reference signal (Reference Signal, RS for short) is generally formed by performing modulation with a certain sequence actually known by a sender and a receiver. After the sender sends the reference signal, the receiver receives according to the actually known sequence, so as to obtain channel situation in a corresponding time period, at a corresponding frequency, or on corresponding antenna resources. By taking a sounding reference signal (Sounding Reference Signal, SRS for short) of a UE as an example, an evolved Node B (evolved Node B, eNB) may schedule one or more cells. In order to enable the eNB to perform uplink scheduling reasonably, the eNB needs to obtain uplink broadband channel information of the user equipment (User Equipment, UE for short), and the uplink broadband channel information needs to be acquired through the SRS of the UE. Specifically, the eNB schedules a resource of the SRS for the user equipment UE, the UE sends the SRS through the resource, and the eNB performs detection after receiving the SRS sent by the UE, so as to obtain the uplink broadband channel information. Generally, the UE is served by only one cell, and the eNB may enable the SRS of the UE in the cell to be orthogonal to SRSs of other UEs in this cell through scheduling, thereby ensuring preferable detecting performance of the SRS.

In a future communications system, a coordinated multi-point (Coordinated Multi-Point, CoMP for short) transmission technology is introduced, so that the UE may be served by multiple cells, and in a CoMP system, the UE capable of being served by multiple cells is referred to as a (CoMP UE, UEm). On uplink, a signal sent by the UEm may be received by detectors of multiple cells, so that the signal transmitted through uplink may acquire diversity gains among the multiple cells, thereby improving the system performance.

During the implementation of the present invention, the inventor finds that, the prior art has not proposed how to configure an RS for the CoMP UE in the CoMP system, so the prior art cannot reduce interference generated by the RS between the UEms in the CoMP system.

### SUMMARY OF THE INVENTION

Embodiments of the present invention aim to provide a method, a device and a user equipment for configuring a reference signal, so as to realize the configuration of RSs for UEms, and avoid interference generated by RSs of the UEms.

An embodiment of the present invention provides a method for configuring a reference signal, which includes:

acquiring group number information of a reference signal allocated for a user equipment UE respectively by each cell;

acquiring, according to the group number information, group offset information of a reference signal of a user equipment UEm served by at least two cells at the same time in the UE, where the group offset information is used to update the group number information of the reference signal of the UEm; and

sending the group offset information to the UEm, so that the UEm acquires new group number information according to the allocated group number information of the reference signal and the group offset information, and sending a reference signal according to the new group number information.

An embodiment of the present invention further provides a method for configuring a reference signal, which includes:

acquiring sending time allocated by each serving cell of a user equipment UEm served by at least two cells at the same time for a UE to send a reference signal, and acquiring time intersection information of the allocated sending time; and

sending the time intersection information to the UEm, so that the UEm sends a reference signal in the time intersection or in a subset of the time intersection.

In another embodiment, the method further includes:

acquiring a total sounding bandwidth allocated by each cell providing services for the UEm for the UE to send the reference signal, and acquiring total sounding bandwidth intersection information of the allocated total sounding bandwidth; and

sending the total sounding bandwidth intersection information or information of one or more subsets of the total sounding bandwidth intersection to the UEm, so that the UEm sends the reference signal in the total sounding bandwidth intersection or in a subset of the total sounding bandwidth intersection.

An embodiment of the present invention further provides a method for configuring a reference signal, which includes:

receiving group offset information of a reference signal allocated by a base station;

acquiring new group number information according to the group offset information and allocated group number information of the reference signal; and

sending a reference signal according to the new group number information.

An embodiment of the present invention further provides a method for configuring a reference signal, which includes:

receiving time intersection information sent by a base station, where the time intersection information is time intersection information acquired by the base station according to sending time allocated by each serving cell of a user equipment UEm served by at least two cells at the same time for a UE to send a reference signal; and

sending a reference signal in the time intersection or in a subset of the time intersection.

In another embodiment, the method further includes:

receiving total sounding bandwidth intersection information or information of one or more subsets of the total sounding bandwidth intersection sent by a base station, wherein the total sounding bandwidth intersection information is total sounding bandwidth intersection information acquired by the base station according to the total sounding bandwidth allocated by each cell providing services for the UEm for a UE to send a reference signal; and

sending a reference signal in the total sounding bandwidth intersection or in a subset of the total sounding bandwidth intersection.

An embodiment of the present invention further provides a device for configuring a reference signal, which includes:

a first acquiring module, configured to acquire group number information of a reference signal allocated for a user equipment UE respectively by each cell;

a second acquiring module, configured to acquire, according to the group number information, group offset information of the reference signal of a user equipment UEm served by at least two cells at the same time in the UE, where the group offset information is used to update the group number information of the reference signal of the UEm; and

a first sending module, configured to send the group offset information to the UEm, so that the UEm acquires new group number information according to the allocated group number information of the reference signal and the group offset information, and sends the reference signal according to the new group number information.

An embodiment of the present invention further provides a device for configuring a reference signal, which includes:

a fifth acquiring module, configured to acquire sending time allocated by each serving cell of a user equipment UEm served by at least two cells at the same time for a UE to send a reference signal, and acquire time intersection information of the allocated sending time; and

a fourth sending module, configured to send the time intersection information to the UEm, so that the UEm sends the reference signal in the time intersection or in a subset of the time intersection.

In another embodiment, the device further includes:

a sixth acquiring module, configured to acquire a total sounding bandwidth allocated by each cell providing services for the UEm for the UE to send the reference signal, and acquire total sounding bandwidth intersection information of the allocated total sounding bandwidth; and

a fifth sending module, configured to send the total sounding bandwidth intersection information to the UEm, so that the UEm sends the reference signal in the total sounding bandwidth intersection or a subset of the total sounding bandwidth intersection.

An embodiment of the present invention further provides a user equipment, which includes:

a first receiving module, configured to receive group offset information of a reference signal allocated by a base station;

a seventh acquiring module, configured to acquire new group number information according to the group offset information and allocated group number information of the reference signal; and

a sixth sending module, configured to send a reference signal according to the new group number information.

An embodiment of the present invention further provides a user equipment, which includes:

a second receiving module, configured to receive time intersection information sent by a base station, where the time intersection information is time intersection information acquired by the base station according to sending time allocated by each serving cell of a user equipment UEm served by at least two cells at the same time for a UE to send a reference signal; and

a seventh sending module, configured to send a reference signal in the time intersection or in a subset of the time intersection.

In another embodiment, the user equipment further includes:

a third receiving module, configured to receive total sounding bandwidth intersection information sent by a base station, wherein the total sounding bandwidth intersection information is the total sounding bandwidth intersection information of acquired by the base station according to the total sounding bandwidth allocated by each cell providing services for the UEm for a UE to send a reference signal; and

an eighth sending module, configured to send a reference signal in the total sounding bandwidth intersection or in a subset of the total sounding bandwidth intersection.

In the method, device and user equipment for configuring a reference signal provided in embodiments of the present invention, group number information of an RS allocated for a UE respectively by each cell is acquired; group offset information of the RS in the UE is acquired according to the group number information; and the group offset information is sent to a UEm, so that the UEm acquires new group number information according to the allocated group number information of the RS and the group offset information, and sends an RS according to the new group number information, thereby avoiding interference generated by the UE in each cell on a scheduled UEm when an eNB schedules the UEm.

### BRIEF DESCRIPTION OF THE DRAWINGS

In order to illustrate the technical solutions in the embodiments of the present invention or in the prior art more clearly, the accompanying drawings required to be used in the description of the embodiment or the prior art are briefly introduced in the following. It is obvious that the accompanying drawings to be described are only a part of the embodiments of the present invention. Other accompanying drawings may further be obtained by persons of ordinary skill in the art according to these accompanying drawings without creative efforts.

FIG. 1 is a schematic structure diagram of a CoMP system;

FIG. 2 is a schematic flow chart of an embodiment of a method for configuring a reference signal of the present invention;

FIG. 3 is a schematic flow chart of another embodiment of a method for configuring a reference signal of the present invention;

FIG. 4 is a schematic flow chart of still another embodiment of a method for configuring a reference signal of the present invention;

FIG. 5 is a schematic flow chart of yet another embodiment of a method for configuring a reference signal of the present invention;

FIG. 6 is a schematic structure diagram of an embodiment of a device for configuring a reference signal of the present invention;

FIG. 7 is a schematic structure diagram of another embodiment of a device for configuring a reference signal of the present invention;

FIG. 8 is a schematic structure diagram of an embodiment of a user equipment of the present invention;

FIG. 9 is a schematic structure diagram of another embodiment of a user equipment of the present invention;

FIG. 10 is a schematic structure diagram of an embodiment of a system for configuring a reference signal applicable to an embodiment of the present invention; and

FIG. 11 is a schematic structure diagram of another embodiment of a system for configuring a reference signal applicable to an embodiment of the present invention.

### DETAILED DESCRIPTION OF THE EMBODIMENTS

The technical solutions in embodiments of the present invention are clearly and completely described in the following with reference to the accompanying drawings. It is obvious that the embodiments to be described are only a part rather than all of the embodiments of the present invention. All other embodiments derived by persons of ordinary skill in the art based on the embodiments of the present invention without creative efforts should fall within the protection scope of the present invention.

The reference signal may be a signal modulated through a sequence, for example, a demodulation reference signal or a sounding reference signal. The demodulation reference signal may be used to demodulate data, and the sounding reference signal may be used to sound channel information.

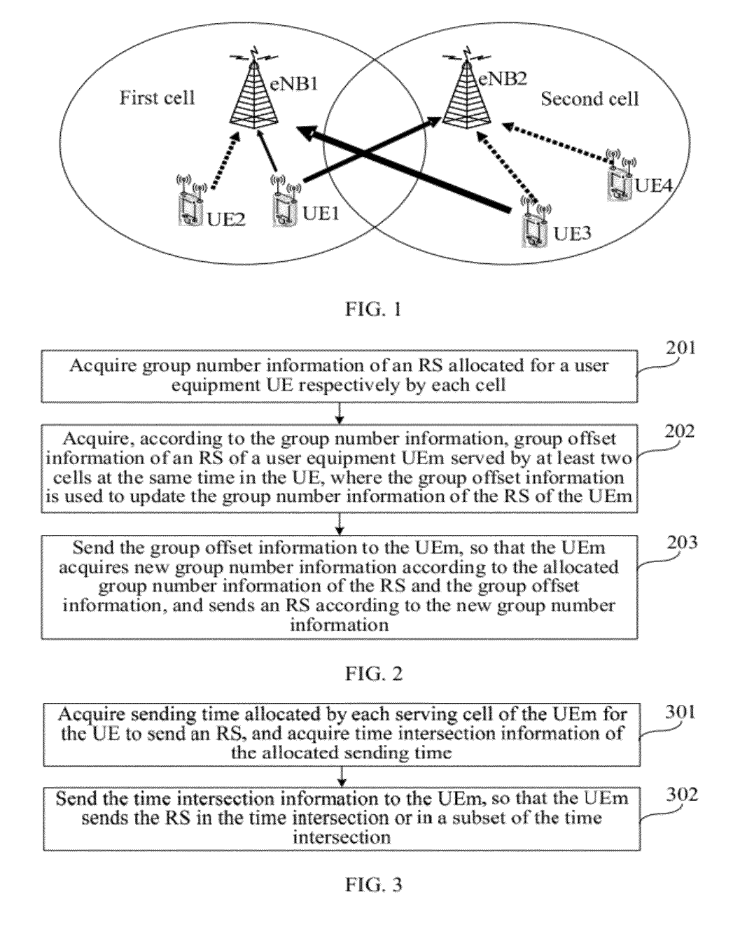

FIG. 1 is a schematic structure diagram of a CoMP system. As shown in FIG. 1, a UE1 in a first cell and a UE3 in a second cell may be provided with services by an eNB1 and an eNB2 at the same time, and belong to CoMP UEs (UEm) in the CoMP system. A UE2 in the first cell can only be provided with services by the eNB1, and a UE4 in the second cell can only be provided with services by the eNB2, and therefore, the UE2 and the UE4 belong to common UEs. In the first cell, through scheduling, the eNB1 may prevent an RS of the UE1 from being interfered by the UE2 in the first cell. In the second cell, if a part of or all resources of the RS used by the UE1 are occupied by the UE3 and the UE4 in the second cell, the eNB2 may be interfered when detecting the RS of the UE1, so that the eNB2 cannot obtain preferable detecting performance. The CoMP system shown in FIG. 1 is only a description, and the number of cells in the CoMP system in the embodiment of the present invention is not limited to the situation that is shown in FIG. 1 where totally two cells, that is, the first cell and the second cell, exist. The number of the first cell and the second cell in the embodiment of the present invention may be several according to actual situations, and the first cell and the second cell may be controlled by one eNB, or respectively controlled by two eNBs.

“Group number information” mentioned in the embodiments of the present invention below may specifically refer to a group number of a group where a sequence adopted by the RS locates. For example, the RS adopts constant amplitude zero auto correlation (Constant Amplitude Zero Auto Correlation, CAZAC for short) sequences, and M CAZAC sequences are divided into N groups (M is a number of all available CAZAC sequences, and N may be the number of the cells); and N group numbers exist in the N groups of CAZAC sequences. Based on attributes of the CAZAC sequence groups, UEs under the same cell use corresponding CAZAC sequences having the same length and under the same group number, and different UEs may perform different circulation shifts on the CAZAC sequence. Since the CAZAC sequences having the same length and under the same group number are orthogonal to one another after being subject to circulation shifts of different steps, the RS interference between different UEs under the same cell may be reduced.

In addition, in order to make the embodiments of the present invention more comprehensible, the group offset information is illustrated in detail with reference to FIG. 1 as follows.

As shown in FIG. 1, the first cell serves the UE2 and the UE1, and the second cell serves the UE3 and the UE4, and in addition, the first cell and the second cell serve the UE1 and the UE3 at the same time, and the UE1 and the UE3 may be CoMP UEs. The first cell and the second cell have different identities (ID), so a group number u1 of the first cell is different from a group number u2 of the second cell. In order to avoid interference generated by a UEm (UE3) in the second cell on a scheduled UEm (UE1) in the first cell when the UEm (UE1) in the first cell is scheduled, the UEms (UE1, UE3) in the first cell and in the second cell need to have the same group number. Specifically, the following three manners may be used to enable all UEms in the first cell and the second cell to update respective group numbers, and enable the group numbers of the UEms to be the same. First, by taking the first cell as a reference, form a new group number for the UEm in the second cell by setting an offset for the group number of the second cell, and the new group number is the same as the group number of the UEm in the first cell, that is, u1=Δ+u2, the new group number is formed by adding Δ to the group number of the UEm in the second cell. Second, by taking the second cell as a reference, form a new group number for the UEm in the first cells by setting an offset for the group number of the first cell, and the new group number is the same as the group number of the UEm in the second cell, that is, u2=Δ+u1, the new group number is formed by adding A to the group number of the UEm in the first cell. Third, after setting an offset for the group number of the first cell and the group number of the second cell, a new group number of the first cell and a new group number of the second cell are enabled to be the same, that is, u1+Δ1=u2+Δ2. Through the three manners, it may be realized that the UEm in the first cell and the UEm in the second cell form new group number information. The foregoing example only takes the UEm in the first cell being the UE1 and the UEm in the second cell being the UE3 as an example. However, the cells in the embodiment of the present invention are not limited to be two cells, and a UEm under multiple cells may be set during specific implementation, and the number of the UEm in each cell is not limited to be one, and multiple UEms may be set during specific implementation according to actual situations.

In addition, a primary cell mentioned in the following embodiments of the present invention may be a serving cell having one function or all functions as follows: determining a parameter of uplink transmission of the UE, sending a signaling to the UE, and/or cooperatively processing an uplink signal of the UE. Other cells serving the UE are referred to as auxiliary cells of the UE.

FIG. 2 is a schematic flow chart of an embodiment of a method for configuring a reference signal of the present invention. As shown in FIG. 2, this embodiment includes the following steps:

Step 201: Acquire group number information of an RS allocated for a user equipment UE respectively by each cell;

Step 202: Acquire, according to the group number information, group offset information of an RS of a user equipment UEm served by at least two cells at the same time in the UE, where the group offset information is used to update the group number information of the RS of the UEm; and

Step 203: Send the group offset information to the UEm, so that the UEm acquires new group number information according to the allocated group number information of the RS and the group offset information, and sends an RS according to the new group number information.

In the method for configuring a reference signal provided in the embodiment of the present invention, group number information of an RS allocated for a UE respectively by each cell is acquired; group offset information of the RS in the UE is acquired according to the group number information; and the group offset information is sent to a UEm, so that the UEm acquires new group number information according to the allocated group number information of the RS and the group offset information, and sends an RS according to the new group number information, thereby avoiding interference generated between the UEms in the cells on when an eNB schedules the UEm.

Further, on the basis of the embodiment shown in FIG. 2, the step 203 may further include:

If the acquired group offset information is a group offset, the group offset is sent to the UEm in each cell, so that the UEm acquires new group number information according to a sum of or a difference between the allocated group number information of the RS and the group offset, so that different UEms have the same group number information of the reference signal. Specifically, illustration is made by taking two cells as an example, that is, a first cell and a second cell exist. The first cell has a group number being u1 and a group offset being 41, and the second cell has a group number being u2 and a group offset being 42. In order to enable new group number information of the UEm in the first cell and the UEm in the second cell to be the same, it may be enabled that u1+Δ1=u2+Δ2 or u1−Δ1=u2−Δ2.

If the group offset information is group offset enabling information, the group offset enabling information is set to the corresponding UEm in each cell, so that after receiving the group offset enabling information, the UEm acquires new group number information according to a sum of or a difference between the allocated group number information of the RS and the preset group offset, so that different UEms have the same group number information of the RS. Specifically, the group offset enabling information may be sent to the UEm in each cell in advance through a downlink signaling. For example, the UEm may be notified of the group offset information used by a physical uplink share channel (Physical Uplink Share Channel, PUSCH for short) through the downlink signaling. The group offset enabling information may be notified to the UEm in each cell only through a signaling of 1 bit, thereby saving the signaling overhead. Moreover, the UEm in each cell acquires the same group number information of the RS according to the group offset enabling information, thereby avoiding the interference generated by the UE in each cell on a scheduled UEm when an eNB schedules the UEm.

Specifically, when a group number corresponding to the group number information obtained through the foregoing manner is greater than a group number N or smaller than 0, a modulus of N may be obtained for the group number corresponding to the group number information, thereby obtaining an available new group number.

If the group offset information is allocated new group number information, the new group number information is sent to the UEm in each cell, so that the UEm serves the allocated new group number information as the new group number information, and therefore, different UEms have the same group number information of the RS. Different UEms have the same group number information of the RS, thereby avoiding the interference generated by the UE in each cell on a scheduled UEm when an eNB schedules the UEm.

Further, on the basis of the embodiment shown in FIG. 2, the embodiment further includes:

configuring an emission parameter of the RS of the UE under each cell, so that the UEm and the UE that only is served by the primary cell of the UEm send the RSs at different time points; or

configuring an emission parameter of the RS of the UE under each cell, so that the UEm and the UE that only is served by the primary cell of the UEm send the RSs at different combs.

Further, on the basis of the embodiment shown in FIG. 2, the embodiment further includes:

acquiring sending time allocated by each cell providing services for the UEm for the UE to send an RS, and acquiring time intersection information of the allocated sending time; and

sending the time intersection information to the UEm, so that the UEm sends the RS in the time intersection or in a subset of the time intersection. Alternatively, information of one or more subsets of the time intersection may be sent only.

Further, on the basis of the embodiment shown in FIG. 2, the embodiment further includes:

acquiring total sounding bandwidth allocated by each cell providing services for the UEm for the UE to send an RS, and acquiring intersection information of the allocated total sounding bandwidth; and

sending the intersection information of the total sounding bandwidth to the UEm, so that the UEm sends the RS in the intersection of the total sounding bandwidth or a subset of the intersection of the total sounding bandwidth. Alternatively, information of one or more subsets of the intersection of the total sounding bandwidth may be sent only. Optionally, the RS here may specifically refer to an SRS.

The UEm sends the RS in the intersection of the total sounding bandwidth or in the subset of the intersection of the total sounding bandwidth, so as to avoid interference caused by the RS of the UEm on other UEs of the auxiliary cell since the total sounding bandwidth of the UEm is greater than the total sounding bandwidth of the auxiliary cell.

Further, on the basis of the embodiment shown in FIG. 2, when each cell is respectively controlled by a different eNB, the embodiment further includes: sharing, by different eNBs, emission parameters of the RSs allocated by the respective cells, where the emission parameter of the RS at least includes the allocated group number information, or the group offset information of the RS of the UEm. Different eNBs share the emission parameters of the RSs allocated by the respective cells.

FIG. 3 is a schematic flow chart of another embodiment of a method for configuring a reference signal. As shown in FIG. 3, this embodiment includes the following steps:

Step 301: Acquire sending time allocated by each serving cell of the UEm for the UE to send an RS, and acquire time intersection information of the allocated sending time; and

Step 302: Send the time intersection information to the UEm, so that the UEm sends the RS in the time intersection or in a subset of the time intersection. Alternatively, information of one or more subsets of the time intersection may be sent only.

In the method for configuring the reference signal provided in the embodiment of the present invention, the sending time allocated by each serving cell for the UE to send the RS is acquired, and the time intersection information of the allocated sending time is acquired, so that the UEm sends the RS in the time intersection or in a subset of the time intersection, thereby avoiding the interference generated by the UE in each cell on a scheduled UEm when an eNB schedules the UEm.

Specifically, if the RS transmission time of the UEm of the primary cell is transmitting every transmission time interval (Transmission Time Interval, TTI for short), the RS total sounding bandwidth of the UEm in the auxiliary cell is transmitting every 2 TTIs; the time intersection of the UEm in the primary cell and the UEm in the auxiliary cell is every 2 TTIs; and a subset of every 2 TTIs may be every 4 TTIs. Therefore, the RS transmission time of the UEm in the primary cell and the UEm in the auxiliary cell may be transmitting every 2 TTIs or every 4 TTIs.

Further, on the basis of the embodiment shown in FIG. 3, the embodiment further includes:

acquiring total sounding bandwidth allocated by each cell providing services for the UEm for the UE to send an RS, and acquiring total sounding bandwidth intersection information of the allocated total sounding bandwidth; and

sending the total sounding bandwidth intersection information to the UEm, so that the UEm sends the RS in the total sounding bandwidth intersection or a subset of the total sounding bandwidth intersection. Alternatively, information of one or more subsets of the intersection of the total sounding bandwidth may be sent only.

The UEm sends the RS in the total sounding bandwidth intersection or in the subset of the total sounding bandwidth intersection, so as to avoid interference caused by the RS of the UEm on other UEs of the auxiliary cell since the total sounding bandwidth of the UEm is greater than the total sounding bandwidth of the auxiliary cell. Optionally, the RS here may specifically refer to an SRS.

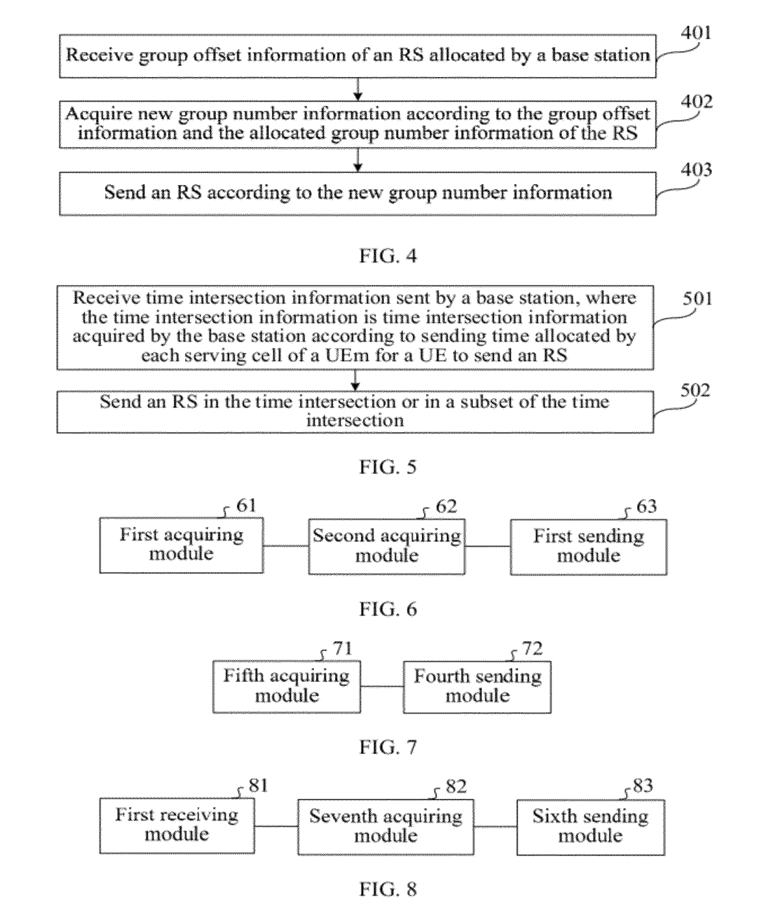

FIG. 4 is a schematic flow chart of still another embodiment of a method for configuring a reference signal. As shown in FIG. 4, this embodiment includes the following steps:

Step 401: Receive group offset information of an RS allocated by a base station;

Step 402: Acquire new group number information according to the group offset information and the allocated group number information of the RS; and

Step 403: Send an RS according to the new group number information.

In the method for configuring a reference signal provided in the embodiment of the present invention, the group offset information of the RS allocated by the base station is received; new group number information is acquired according to the group offset information and the allocated group number information of the RS; and an RS is sent according to the new group number information, thereby avoiding the interference generated by the UE in each cell on a scheduled UEm when an eNB schedules the UEm.

Further, on the basis of the embodiment shown in FIG. 4, the step 402 may specifically include:

if the group offset information is a group offset, acquiring new group number information according to a sum of or a difference between the allocated group number information of the RS and the group offset, so that the new group number information is the same as the group number information of another UEm;

if the group offset information is group offset enabling information, after receiving the group offset enabling information, acquiring, by the UEm, new group number information according to a sum of or a difference between the allocated group number information of the RS and a preset group offset, so that the new group number information is the same as the group number information of another UEm; and

if the group offset information specifically is allocated new group number information, serving the allocated new group number information as the new group number information, so that the new group number information is the same as the group number information of another UEm.

Further, on the basis of the embodiment shown in FIG. 4, the step 403 may specifically include:

sending the RS at a time point different from a UE only served by a primary cell thereof according to a configured emission parameter of the RS; or

sending the RS at a comb different from a UE only served by a primary cell thereof according to a configured emission parameter of the RS.

FIG. 5 is a schematic flow chart of yet another embodiment of a method for configuring a reference signal. As shown in FIG. 5, this embodiment includes the following steps:

Step 501: Receive time intersection information sent by a base station, where the time intersection information is time intersection information acquired by the base station according to sending time allocated by each serving cell of a UEm for a UE to send an RS; and

Step 502: Send an RS in the time intersection or in a subset of the time intersection.

In the method for configuring a reference signal provided in the embodiment of the present invention, the time intersection information sent by the base station is received, and the UEm sends the RS in the time intersection or in a subset of the time intersection, thereby avoiding the interference generated by the UE in each cell on a scheduled UEm when an eNB schedules the UEm.

Further, on the basis of the embodiment shown in FIG. 5, the embodiment further includes:

receiving intersection information of a total sounding bandwidth sent by a base station, where the total sounding bandwidth intersection information is the total sounding bandwidth intersection information acquired by the base station according to the total sounding bandwidth allocated by each cell providing services for the UEm for a UE to send a reference signal; and

sending an RS in the total sounding bandwidth intersection or in a subset of the total sounding bandwidth intersection. Optionally, the RS here may specifically refer to an SRS.

FIG. 6 is a schematic structure diagram of an embodiment of a device for configuring a reference signal of the present invention. As shown in FIG. 6, this embodiment includes: a first acquiring module 61, a second acquiring module 62, and a first sending module 63.

The first acquiring module 61 acquires group number information of a reference signal allocated for a user equipment UE respectively by each cell; the second acquiring module 62 acquires, according to the group number information acquired by the first acquiring module 61, group offset information of a reference signal of a user equipment UEm served by at least two cells at the same time in the UE, where the group offset information is used to update the group number information of the reference signal of the UEm; the first sending module 63 sends the group offset information acquired by the second acquiring module 62 to the UEm, so that the UEm acquires new group number information according to the allocated group number information of the reference signal and the group offset information, and sends a reference signal according to the new group number information.

In the device for configuring a reference signal provided in the embodiment of the preset invention, the first acquiring module 61 acquires group number information of an RS allocated for a UE respectively by each cel; the second acquiring module 62 acquires group offset information of the RS in the UE according to the group number information; the first sending module 63 sends the group offset information to the UEm, so that the UEm acquires new group number information according to the allocated group number information of the RS and the group offset information, and sends an RS according to the new group number information, thereby avoiding the interference generated by the UE in each cell on a scheduled UEm when an eNB schedules the UEm.

Further, on the basis of the embodiment shown in FIG. 6, this embodiment may further include: a first configuring module and/or a second configuring module. The first configuring module is configured to configure an emission parameter of the reference signal of the UE under each cell, so that the UEm and the UE that only is served by a primary cell of the UEm send the reference signals at different time points; or, the second configuring module is configured to configure an emission parameter of the reference signal of the UE under each cell, so that the UEm and the UE that only is served by a primary cell of the UEm send the reference signals at different combs.

Further, on the basis of the embodiment shown in FIG. 6, this embodiment may further include: a third acquiring module and a second sending module. The third acquiring module is configured to acquire sending time allocated by each cell providing services for the UEm for the UE to send the reference signal, and acquire time intersection information of the allocated sending time; and the second sending module, configured to send the time intersection information to the UEm, so that the UEm sends the reference signal in the time intersection or in a subset of the time intersection.

Further, on the basis of the embodiment shown in FIG. 6, this embodiment may further include: a fourth acquiring module and a third sending module. The fourth acquiring module is configured to acquire a total sounding bandwidth allocated by each cell providing services for the UEm for the UE to send the reference signal, and acquire total sounding bandwidth intersection information of the allocated total sounding bandwidth; and the third sending module, configured to send the intersection information of the total sounding bandwidth to the UEm, so that the UEm sends the reference signal in the total sounding bandwidth intersection or a subset of the total sounding bandwidth intersection. Optionally, the RS here may specifically refer to an SRS.

Further, on the basis of the embodiment shown in FIG. 6, this embodiment may further include: a sharing module. The sharing module is configured to, when each cell is respectively controlled by a different evolved Node B eNB, enable the different eNBs to share emission parameters of reference signals allocated by the respective cells, where the emission parameter of the reference signal at least comprises the allocated group number information, or the group offset information of the reference signal of the UEm.

FIG. 7 is a schematic structure diagram of another embodiment of a device for configuring a reference signal of the present invention. As shown in FIG. 7, this embodiment includes: a fifth acquiring module 71 and a fourth sending module 72.

The fifth acquiring module 71 acquires sending time allocated by each serving cell of a user equipment UEm served by at least two cells at the same time for a UE to send a reference signal, and acquires time intersection information of the allocated sending time; and the fourth sending module 72 sends the time intersection information acquired by the fifth acquiring module 71 to the UEm, so that the UEm sends the reference signal in the time intersection or in a subset of the time intersection.

In the device for configuring the reference signal provided in the embodiment of the present invention, the fifth acquiring module 71 acquires the sending time allocated by each serving cell for the UE to send the RS, and acquires the time intersection information of the allocated sending time, so that the UEm sends the RS in the time intersection or in a subset of the time intersection, thereby avoiding the interference generated by the UE in each cell on a scheduled UEm when an eNB schedules the UEm.

Further, on the basis of the embodiment shown in FIG. 7, this embodiment may further include: a sixth acquiring module and a fifth sending module. The sixth acquiring module is configured to acquire a total sounding bandwidth allocated by each cell providing services for the UEm for the UE to send the reference signal, and acquire total sounding bandwidth intersection information of the allocated total sounding bandwidth; and the fifth sending module, configured to send the intersection information of the total sounding bandwidth to the UEm, so that the UEm sends the reference signal in the total sounding bandwidth intersection or a subset of the total sounding bandwidth intersection. Optionally, the RS here may specifically refer to an SRS.

FIG. 8 is a schematic structure diagram of an embodiment of a user equipment of the present invention. As shown in FIG. 8, this embodiment includes: a first receiving module 81, a seventh acquiring module 82, and a sixth sending module 83.

The first receiving module 81 receives group offset information of a reference signal allocated by a base station; the seventh acquiring module 82 acquires new group number information according to the group offset information received by the first receiving module 81 and the allocated group number information of the reference signal; and the sixth sending module 83 sends a reference signal according to the new group number information acquired by the seventh acquiring module 82.

In the user equipment provided in the embodiment of the present invention, the first receiving module 81 receives the group offset information of the RS allocated by the base station; the seventh acquiring module 82 acquires new group number information according to the group offset information and the allocated group number information of the RS; and the sixth sending module 83 sends an RS according to the new group number information, thereby avoiding the interference generated by the UE in each cell on a scheduled UEm when an eNB schedules the UEm.

Further, on the basis of the embodiment shown in FIG. 8, the seventh acquiring module 82 may further include: a first acquiring unit, and/or a second acquiring unit, and/or a third acquiring unit.

If the group offset information is a group offset, the first acquiring unit is configured to acquire new group number information according to a sum of or a difference between the allocated group number information of the reference signal and the group offset, so that the new group number information is the same as group number information of another user equipment UEm served by at least two cells at the same time;

If the group offset information is group offset enabling information, the second acquiring unit is configured to, after receiving the group offset enabling information, acquire new group number information according to a sum of or a difference between the allocated group number information of the reference signal and a preset group offset, so that the new group number information is the same as group number information of another user equipment UEm served by at least two cells at the same time; and

If the group offset information is allocated new group number information, the third acquiring unit is configured to serve the allocated new group number information as new group number information, so that the new group number information is the same as group number information of another user equipment UEm served by at least two cells at the same time.

On the basis of the embodiment shown in FIG. 8, the sixth sending module 82 may further include: a first sending unit, and/or a second sending unit. The first sending unit is configured to send the reference signal at a time point different from a UE only served by a primary cell thereof according to a configured emission parameter of the reference signal; and the second sending unit is configured to send the reference signal at a comb different from a UE only served by a primary cell thereof according to a configured emission parameter of the reference signal.

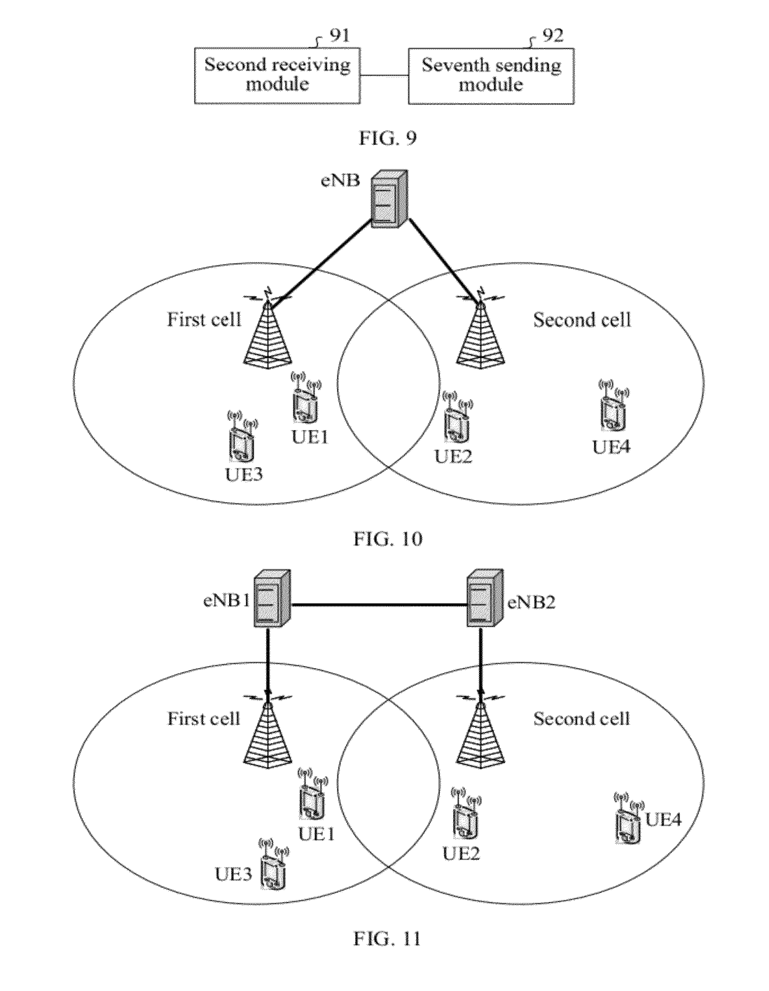

FIG. 9 is a schematic structure diagram of another embodiment of a user equipment of the present invention. As shown in FIG. 9, this embodiment includes: a second receiving module 91, and a seventh sending module 92.

The second receiving module 91 receives time intersection information sent by a base station, where the time intersection information is time intersection information acquired by the base station according to sending time allocated by each serving cell of a user equipment UEm served by at least two cells at the same time for sending a reference signal to a UE; and the seventh sending module 92 sends a reference signal in the time intersection or in a subset of the time intersection received by the second receiving module 91.

In the user equipment provided in the embodiment of the present invention, the second receiving module 91 receives the time intersection information sent by the base station, and the seventh sending module 92 sends the RS in the time intersection or in a subset of the time intersection, thereby avoiding the interference generated by the UE in each cell on a scheduled UEm when an eNB schedules the UEm.

Further, on the basis of the embodiment shown in FIG. 9, this embodiment may further include: a third receiving module and an eighth sending module. The third receiving module is configured to receive intersection information of total sounding bandwidth sent by a base station, where the total sounding bandwidth intersection information is total sounding bandwidth intersection information acquired by the base station according to the total sounding bandwidth allocated by each cell providing services for the UEm for a UE to send a reference signal; and the eighth sending module is configured to send a reference signal in the total sounding bandwidth intersection or in a subset of the total sounding bandwidth intersection. Optionally, the RS here may specifically refer to an SRS.

FIG. 10 is a schematic structure diagram of an embodiment of a system for configuring a reference signal applicable to an embodiment of the present invention. As shown in FIG. 10, an eNB connects to a first cell and a second cell in a wired manner, and controls UEs in the first cell and the second cell. A UE1 is a UEm in the first cell that can be served by the first cell and the second cell; a UE2 is a UEm in the second cell that can be served by the first cell and the second cell; a UE3 is a common UE that can only be served by the first cell; and a UE4 is a common UE that can only be served by the second cell.

The eNB control resource information of RSs of the first cell and the second cell at the same time, and therefore, RSs between the UE1, UE2, and other UEs (the UE3, UE4) may be coordinated directly through configuring parameters. Specifically, the foregoing description may be implemented through the following manner. The eNB acquires group number information of RSs of the UE (UE1) in the first cell and the UE (UE2) in the second cell, and acquires group offset information of the RS of the UEms (UE1, UE2) in the first cell and the second cell according to the group number information, so that the group number information of the RSs of the UE1 in the first cell and the UE2 in the second cell are the same as new group number information formed by the group offset information. The eNB sends the new group number information to the UE1 in the first cell and the UE2 in the second cell, so that the UE1 in the first cell and the UE2 in the second cell send RSs according to the new group number information.

The UE1 and the UE2 that are served by the first cell and the second cell have the same new group number information, so that the UE1 and the UE2 that are served by the first cell and the second cell send the RSs according to the same new group number information, thereby avoiding the interference generated by the UE2 in the second cell on the scheduled UE1 when the eNB schedules the UE1 in the first cell.

FIG. 11 is a schematic structure diagram of another embodiment of a system for configuring a reference signal applicable to an embodiment of the present invention. As shown in FIG. 11, an eNB1 and an eNB2 are connected through a signaling interface between eNBs; the eNB1 is connected to a first cell in a wired manner; the eNB2 is connected to a second cell in a wired manner; the eNB1 controls UEs (UE1, UE3) in the first cell; and the eNB2 controls UEs (UE2, UE4) in the second cell. The UE1 is a UEm in the first cell that can be served by the first cell and the second cell; the UE2 is a UEm in the second cell that can be served by the first cell and the second cell; the UE3 is a common UE in the first cell; and the UE4 is a common UE in the second cell.

The eNB1 controls resource information of RSs of the UEs in the first cell; the eNB2 controls resource information of RSs of the UEs in the second cell; and the eNB1 and the eNB2 are independent with each other, so the embodiment of the present invention enables the resource information of the RSs of the UEms to be orthogonal, thereby avoiding the interference generated between the RS of the UEm in the first cell under the eNB 1 and the RS of the UEm in the second cell under the eNB2.

Specifically, the eNB1 acquires, through an interface, first configuration information of the RS of the UEm (UE2) in the second cell under the eNB2, acquires second configuration information of the RS of the UEm (UE1) in the first cell under the eNB1, and sends the second configuration information to the UE1 under the eNB1, so that the UE1 sends the RS to the eNB2 according to the second configuration information. The first configuration information is orthogonal to the second configuration information, so the UE1 may avoid the interference of the UEs (UE2, UE4) of the eNB2 when sending the RS to the eNB2.

Further, the first configuration information and the second configuration information may specifically be: sending time information of the RS, sending bandwidth information of the RS (may specifically be: initial frequency of a sending bandwidth, a sequence length, a comb and/or total sounding bandwidth), information of a sequence where the RS locates (including group number information, group offset information, group number information and/or circulation shift of UE).

The embodiments of the present invention may specifically be applied in a CoMP system, and in the CoMP system, specific parameters in the cells related to the RSs in multiple cells are configured cooperatively, so that when the eNB schedules the UE, in the serving cells of the UEm, the RS used by the UEm is orthogonal to the RSs of other UEms and common UEs, thereby avoiding the interference between cells.

Persons of ordinary skill in the art may understand that all or a part of the steps of the method according to the embodiments of the present invention may be implemented by a program instructing relevant hardware. The program may be stored in a computer readable storage medium. When the program is run, the steps of the method according to the embodiments of the present invention are performed. The storage medium may be any medium that is capable of storing program codes, such as a ROM, a RAM, a magnetic disk, and an optical disk.

Finally, it should be noted that, the above embodiments are merely provided for describing the technical solutions of the present invention, but are not intended to limit the present invention. It should be understood by persons of ordinary skill in the art that: although the present invention has been described in detail with reference to the embodiments, modifications may still be made to the technical solutions described in the embodiments, or equivalent replacements may be made to some technical features in the technical solutions, and these modifications or replacements do not cause the essence of corresponding technical solutions to depart from the spirit and scope of the technical solutions of present invention.

What is claimed is:

1. A method for configuring a reference signal, comprising:
acquiring, by a base station, group number information of a reference signal allocated for a user equipment (UE) respectively by each cell;
acquiring, by the base station, according to the group number information, group offset information of a reference signal of a user equipment UEm served by at least two cells at the same time in the UE, wherein the group offset information is used to update the group number information of the reference signal of the UEm; and
sending, by the base station, the group offset information to the UEm, so that the UEm acquires new group number information according to the allocated group number information of the reference signal and the group offset information, and sends a reference signal according to the new group number information.

2. The method according to claim 1, wherein:
the acquiring, by the UEm, new group number information according to the allocated group number information of the reference signal and the group offset information specifically comprises: acquiring, by the UEm, new group number information according to the allocated group number information of the reference signal and the group offset information, so that different UEms have the same group number information of the reference signal.

3. The method according to claim 2, wherein:
the group offset information is a group offset, and the acquiring, by the UEm, new group number information according to the allocated group number information of the reference signal and the group offset information, so that different UEms have the same group number information of the reference signal specifically comprises: acquiring, by the UEm, new group number information according to a sum of or a difference between the allocated group number information of the reference signal and the group offset information, so that different UEms have the same group number information of the reference signal; or,
the group offset information is specifically group offset enabling information, and the acquiring, by the UEm, new group number information according to the allocated group number information of the reference signal and the group offset information, so that different UEms have the same group number information of the reference signal specifically comprises: after receiving the group offset enabling information, acquiring, by the UEm, new group number information according to a sum of or a difference between the allocated group number information of the reference signal and a preset group offset, so that different UEms have the same group number information of the reference signal; or,
the group offset information is specifically allocated new group number information, and the acquiring, by the UEm, new group number information according to the allocated group number information of the reference signal and the group offset information, so that different UEms have the same group number information of the reference signal specifically comprises: serving, by the UEm, the allocated new group number information as the new group number information, so that different UEms have the same group number information of the reference signal.

4. The method according to claim 1, further comprising:
configuring, by the base station, an emission parameter of the reference signal of the UE under each cell, so that the UEm and the UE that only is served by a primary cell of the UEm send the reference signals at different time points; or,
configuring, by the base station, an emission parameter of the reference signal of the UE under each cell, so that the UEm and the UE that only is served by a primary cell of the UEm send the reference signals at different combs.

5. The method according to claim 1, further comprising:
acquiring, by the base station, sending time allocated by each cell providing services for the UEm for the UE to send the reference signal, and acquiring time intersection information of the allocated sending time; and
sending, by the base station, the time intersection information or information of one or more subsets of the time intersection to the UEm, so that the UEm sends the reference signal in the time intersection or in a subset of the time intersection.

6. The method according to claim 1, further comprising:
acquiring, by the base station, a total sounding bandwidth allocated by each cell providing services for the UEm for the UE to send the reference signal, and acquiring intersection information of the allocated total sounding bandwidth; and
sending, by the base station, intersection information of the total sounding bandwidth or information of one or more subsets of an intersection of the total sounding bandwidth to the UEm, so that the UEm sends the reference signal in the intersection of the total sounding bandwidth or in a subset of the intersection of the total sounding bandwidth.

7. The method according to claim 1, when each cell is respectively controlled by a different evolved Node B (eNB), further comprising: sharing, by the different eNBs, emission parameters of reference signals allocated by the respective cells, wherein the emission parameter of the reference signal at least comprises the allocated group number information, or the group offset information of the reference signal of the UEm.

8. The method according to claim 1, wherein the reference signal comprises: a signal modulated through a sequence.

9. A method for configuring a reference signal, comprising:
receiving, by a user equipment UEm, group offset information of a reference signal allocated by a base station;
acquiring, by the UEm, new group number information according to the group offset information and allocated group number information of the reference signal; and
sending, by the UEm, a reference signal according to the new group number information.

10. The method according to claim 9, wherein:
the acquiring, by the UEm, new group number information according to the group offset information and allocated group number information of the reference signal comprises: acquiring, by the UEm, new group number information according to the group offset information and allocated group number information of the reference signal, so that the new group number information is the same as group number information of another user equipment UEm served by at least two cells at the same time.

11. The method according to claim 10, wherein:
the group offset information is a group offset, and the acquiring, by the UEm, new group number information according to the group offset information and the allocated group number information of the reference signal, so that the new group number information is the same as group number information of another user equipment UEm served by at least two cells at the same time specifically comprises: acquiring, by the UEm, new group number information according to a sum of or a difference between the allocated group number information of the reference signal and the group offset information, so that the new group number information is the same as group number information of another user equipment UEm served by at least two cells at the same time; or,
the group offset information is group offset enabling information, and the acquiring, by the UEm, new group number information according to the group offset information and the allocated group number information of the reference signal, so that the new group number information is the same as group number information of another user equipment UEm served by at least two cells at the same time specifically comprises: after receiving the group offset enabling information, acquiring, by the UEm, new group number information according to a sum of or a difference between the allocated group number information of the reference signal and a preset group offset, so that the new group number information is the same as group number information of another user equipment UEm served by at least two cells at the same time; or,
the group offset information is specifically allocated new group number information, and the acquiring, by the UEm, new group number information according to the group offset information and the allocated group number information of the reference signal, so that the new group number information is the same as group number information of another user equipment UEm served by at least two cells at the same time specifically comprises: serving, by the UEm, the allocated new group number information as the new group number information, so that the new group number information is the same as group number information of another user equipment UEm served by at least two cells at the same time.

12. The method according to claim 9, wherein the sending the reference signal according to the new group number information comprises:
sending, by the UEm, the reference signal at a time point different from a UE only served by a primary cell thereof according to a configured emission parameter of the reference signal; or
sending, by the UEm, the reference signal at a comb different from a UE only served by a primary cell thereof according to a configured emission parameter of the reference signal.

13. A device for configuring a reference signal, comprising:
a first acquiring module, configured to acquire group number information of a reference signal allocated for a user equipment UE respectively by each cell;
a second acquiring module, configured to acquire, according to the group number information, group offset information of a reference signal of a user equipment UEm served by at least two cells at the same time in the UE, where the group offset information is used to update the group number information of the reference signal of the UEm; and
a first sending module, configured to send the group offset information to the UEm, so that the UEm acquires new group number information according to the allocated group number information of the reference signal and the group offset information, and sends the reference signal according to the new group number information.

14. The device according to claim 13, further comprising:
a first configuring module, configured to configure an emission parameter of the reference signal of the UE under each cell, so that the UEm and the UE that only is served by a primary cell of the UEm send the reference signals at different time points; or,
a second configuring module, configured to configure an emission parameter of the reference signal of the UE under each cell, so that the UEm and the UE that only is served by a primary cell of the UEm send the reference signals at different combs.

15. The device according to claim 13, further comprising:
a third acquiring module, configured to acquire sending time allocated by each cell providing services for the UEm for the UE to send the reference signal, and acquire time intersection information of the allocated sending time; and
a second sending module, configured to send the time intersection information to the UEm, so that the UEm sends the reference signal in the time intersection or in a subset of the time intersection.

16. The device according to claim 13, further comprising:
a fourth acquiring module, configured to acquire a total sounding bandwidth allocated by each cell providing services for the UEm for the UE to send the reference signal, and acquire total sounding bandwidth intersection information of the allocated total sounding bandwidth; and
a third sending module, configured to send the intersection information of the total sounding bandwidth to the UEm, so that the UEm sends the reference signal in the total sounding bandwidth intersection or a subset of the total sounding bandwidth intersection.

17. The device according to claim 13, further comprising: a sharing module; wherein
the sharing module is configured to, when each cell is respectively controlled by a different evolved Node B eNB, enable the different eNBs to share emission parameters of reference signals allocated by the respective cells, wherein the emission parameter of the reference signal at least comprises the allocated group number information, or the group offset information of the reference signal of the UEm.

18. A user equipment, comprising:
a first receiving module, configured to receive group offset information of a reference signal allocated by a base station;
a seventh acquiring module, configured to acquire new group number information according to the group offset information and allocated group number information of the reference signal; and
a sixth sending module, configured to send a reference signal according to the new group number information.

19. The user equipment according to claim 18, wherein the seventh acquiring module is specifically configured to acquire new group number information according to the group offset information and the allocated group number information of the reference signal, so that the new group number information is the same as group number information of another user equipment UEm served by at least two cells at the same time.

20. The user equipment according to claim 18, wherein the seventh acquiring module comprises at least one of the following units: a first acquiring unit, a second acquiring unit, and a third acquiring unit; wherein
the group offset information is a group offset, and the first acquiring unit is configured to acquire new group number information according to a sum of or a difference between the allocated group number information of the reference signal and the group offset, so that the new group number information is the same as group number information of another user equipment UEm served by at least two cells at the same time;
the group offset information is group offset enabling information, and the second acquiring unit is configured to, after receiving the group offset enabling information, acquire new group number information according to a sum of or a difference between the allocated group number information of the reference signal and a preset group offset, so that the new group number information is the same as group number information of another user equipment UEm served by at least two cells at the same time; and
the group offset information is allocated new group number information, and the third acquiring unit is configured to serve the allocated new group number information as new group number information, so that the new group number information is the same as group number information of another user equipment UEm served by at least two cells at the same time.

21. The user equipment according to claim 18, wherein the sixth sending module comprises at least one of the following units: a first sending unit, and a second sending unit; wherein
the first sending unit is configured to send the reference signal at a time point different from a UE only served by a primary cell thereof according to a configured emission parameter of the reference signal; and
the second sending unit is configured to send the reference signal at a comb different from a UE only served by a primary cell thereof according to a configured emission parameter of the reference signal.
